(19) United States
(12) Patent Application Publication
(10) Pub. No.: US 2002/0016765 A1
(43) Pub. Date: Feb. 7, 2002

(54) System and method for third-party payment processing

(76) Inventor: David Sacks, Palo Alto, CA (US)

Correspondence Address: PARK, VAUGHAN & FLEMING LLP, 702 MARSHALL STREET, SUITE 310, REDWOOD CITY, CA, 94063, US

(21) Appl. No.: 09/901,962

(22) Filed: Jul. 10, 2001

Related U.S. Application Data
(60) Provisional application No. 60/217,291, filed on Jul. 11, 2000.
(60) Provisional application No. 60/217,342, filed on Jul. 11, 2000.

(51) Int. Cl. G06F 17/60

(52) U.S. Cl. 705/39

(57) ABSTRACT

A system and method for handling a payment between a buyer/payor to a seller/payee at a third-party site. The buyer is redirected from the seller to the third-party payment processor to process payment for an electronic transaction. Details of the transaction may be received with the buyer's connection. The buyer may be electrically disconnected from the seller to prevent financial or private data from being passed to the seller. The third-party payment processor establishes an account for the buyer if the buyer does not have an account. The buyer's account may be funded by a credit card, debit card or bank account, and may be identified with an electronic mail address. The third-party payment processor transfers payment from the buyer to the seller (e.g., through a seller account with the payment processor). The buyer may be redirected to the seller after completion or cancellation of the payments.

### BACKGROUND

This invention relates to the field of computer systems. More particularly, a system and method are provided for processing, at a third-party site (e.g., website), a buyer's payment for an electronically conducted transaction with an online seller.

In existing online transaction systems, a seller processes payment from a buyer without the buyer dealing directly with any other entity (besides the seller) that may be involved in the transaction. This requires the seller to obtain credit card data, bank account information and/or other financial data from the buyer. The seller then passes this information to an allied payment processor, possibly via a back-end electronic connection (e.g., using XML (eXtensible Markup Language)), which never has contact with the customer. In order to process payments in this manner, a seller must implement appropriate security and privacy arrangements to protect the buyer's financial data. Such arrangements usually entail extensive system engineering and programming (e.g., C++, CGI (Common Gateway Interface)). The cost of hosting such processing capability on a seller's website is thus significant, and constant maintenance is required in order to adequately protect the buyer's and seller's sensitive information and to support the back-end connection to the payment processor.

In addition, because each seller implements its own payment processing capability, isolated from other sellers, a buyer is required to provide his or her payment information separately for each seller. Thus, for each new seller that a buyer deals with, the risk of exposure, misappropriation and/or fraudulent use of the buyer's financial increases.

### SUMMARY

In one embodiment of the invention, a system and method are provided for enabling a third party to process an electronic payment between a buyer and a seller. In this embodiment, a buyer is directed or redirected to the third-party payment processor (e.g., a website operated by the third-party payment processor) via an HTML (HyperText Markup Language) link after or during a session on the seller's website. Contained in the link is information regarding the terms of the transaction between the buyer and the seller, which is thereby posted to the third-party payment processor's website. The buyer's financial data (e.g., credit card number, bank account information) is only captured by the payment processor, and not the seller, thereby limiting the exposure of the data. In addition, because the third-party processor may handle payments for numerous sellers, a buyer may already be registered or otherwise known to the processor, thereby limiting the time and effort needed by the buyer to complete subsequent transactions.

Thus, in this embodiment of the invention, a seller is able to outsource its payment processing burden to a third party by placing one or more special HTML links on the seller's website. This simplifies the seller's task of accepting secure payments on the Internet, or other publicly accessible network, while assuring buyers that their payments will be processed securely and privately. In one implementation of this embodiment, the third-party payment processor may become a known or branded financial intermediary.

In an embodiment of the invention, when a buyer is connected to the payment processing system, its connection with the seller is terminated. Details of a transaction between the buyer and seller (e.g., price, item name, seller identity, shipping cost) may be received with the connection. The payment processing system may also receive an address (e.g., a URL) of a location to which the buyer should be returned once the secure financial transaction has completed. Multiple locations may be identified and different ones may be applied depending on whether the payment processing is successful or unsuccessful, and whether or not the buyer cancels the transaction.

If the buyer is not known or registered with the system (e.g., does not have an account), an account for electronically transferring value may be created. The account may be named or identified by a unique identifier of the buyer, such as an electronic mail address. The buyer may also be required to provide details of one or more payment mechanisms (e.g., credit cards, bank accounts) for funding the buyer's account and/or making purchases. A known buyer may be recognized by a cookie, an account name provided by the buyer, etc.

After the necessary transaction and payment details are provided and displayed for the buyer's verification, the payment processing system initiates the necessary value transfers. One transfer may be performed to receive the necessary value from the buyer's account or payment mechanism, and another to send the seller's proceeds to its account with the system, a bank account, etc.

After the buyer's payment is processed, or if it is cancelled or unsuccessful, the buyer may be redirected or reconnected to a location (e.g., web site) specified by the seller.

### DESCRIPTION OF THE FIGURES

FIG. 1 is a block diagram depicting an electronic environment in which a third party handles payment processing for a seller's transaction with a buyer, in accordance with an embodiment of the present invention.

FIG. 2 is a block diagram of a payment processing system according to one embodiment of the invention.

FIG. 3 is a flowchart illustrating one method of processing a buyer's payment at a third-party payment processor in accordance with an embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention might be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

In one embodiment of the invention, a system and method are provided for processing payment for an online or electronic transaction between a buyer (e.g., a payor or debtor) and a seller (e.g., a payee or creditor) through a third party. Illustratively, a buyer making a purchase at a seller site or system is redirected or transferred to the third party when a transaction is to be consummated or payment information is to be provided by the buyer. The third-party payment processor (“payment processor”) receives a connection from the buyer and processes the buyer's payment using information provided by the user and/or details of the present transaction received with the buyer's connection. One skilled in the art will appreciate that the third party may be employed by multiple sellers, thereby allowing it to provide buyers with common interfaces, historical tracking of transactions, centralized accounting, and so on. In particular, the third party may recognize a buyer from one session to another. For example, in an embodiment of the invention, a buyer's use of the system is facilitated by registering him or her so that future payment processing can be performed simply by verifying the seller's identity (e.g., with a password or other security mechanism).

When a seller and buyer have arranged terms of a transaction (e.g., a buyer selects an item from a seller's online catalog), the buyer is transferred or redirected to the third-party payment processor. With the buyer's connection, the payment processor may receive various information, such as a description of an item being purchased (e.g., name, item number, quantity, color, price), the seller's identity (e.g., name, electronic mail address), a URL (Uniform Resource Locator) or other location to forward the user's connection to after processing the payment, etc. The seller may be an online merchant, an auction site, a service provider, etc.

Illustratively, the seller's site or system may be configured to redirect the buyer's connection (i.e., to the payment processor) using just HTML (Hypertext Markup Language) or a similar language or protocol. In particular, the seller need not employ complicated engineering solutions or programming (e.g., using CGI—Common Gateway Interface) to handle buyer payments or data. The HTML source code and/or appropriate links (e.g., a button or URL) may be provided by the payment processor, may be generated by the seller according to the payment processor's guidelines, etc.

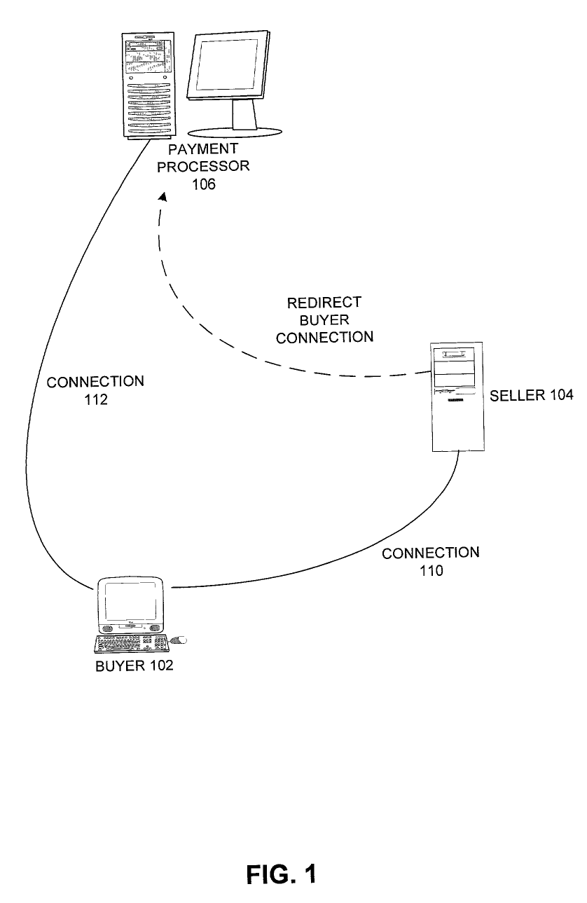

FIG. 1 is a block diagram depicting one embodiment of the invention. In FIG. 1, buyer 102 first connects to seller or seller site 104 to make a purchase or arrange some other form of electronic transaction. Buyer 102 may employ virtually any type of communication or computing device, such as a computer (e.g., portable, handheld, desktop), a smart phone (e.g., WAP (Wireless Access Protocol)), a two-way pager, etc. Similarly, seller 104 may comprise any number, type or form of computer systems or web sites, using any type of application, web or communication server.

When buyer 102 makes a product selection or otherwise agrees to the terms of a transaction with seller 104, he or she is redirected to payment processor 106. This redirection may occur, for example, when the buyer indicates a desire to consummate the transaction (e.g., to pay for a purchase or to checkout), selects a payment option, selects a link offered by the seller, etc.

In the embodiment of FIG. 1, the buyer's financial information is transmitted over connection 112, to payment processor 106, rather than over connection 110 to seller 104. Thus, the seller never receives the buyer's credit card number or banking information and the seller need not implement the necessary security architecture to protect such information. In this embodiment, connection 112 is a secure connection, using a secure protocol (e.g., HTTPS—Hypertext Transport Protocol Secure), an encrypted link, or some other form of protection.

At payment processor site 106, buyer 102 may encounter an interface common to all buyers that are redirected to payment processor 106. Alternatively, the interface employed by the payment processor may be branded or customized according to the seller from which the buyer was redirected, may be personalized for the buyer, etc.

Along with the buyer's connection, payment processor 106 receives various terms of the transaction and/or other information. The payment processor then solicits payment information from the buyer and/or retrieves such data from storage if the buyer is already known. The buyer's identity may be learned or verified through a cookie, a parameter received with the buyer's connection, a username and password, or through some other method. Payment processor 106 includes the necessary CGI scripts, programming and engineering for initiating credit card and/or debit card transactions, electronic checks (i.e., Automated Clearing House transactions), and any other form of electronic payment that may be desired.

In one embodiment of the invention, payment processor 106 comprises a system for transferring value between users. In this embodiment, one user (e.g., a buyer) may transfer value to another user (e.g., a seller) using an account name or other identity of the user. In particular, a user account may be configured around the user's electronic mail address, telephone number, social security number or other unique moniker. A seller's unique identifier or account name may be passed to payment processor 106 with the buyer's connection. In general, however, a buyer may transfer value (e.g., the cost of a transaction) to a seller in an embodiment of the invention as long as the seller's unique identifier is provided to the third-party payment processor. Illustratively, the third-party payment processor may be a master merchant enabling multiple merchants to receive credit card payments. U.S. patent application Ser. No. 09/560,215, entitled “System and Method for Electronically Exchanging Value Among Distributed Users” and commonly assigned with the present application, describes a system for exchanging value between users, which may be implemented as part of or in conjunction with payment processor 106, and is hereby incorporated by reference.

In an embodiment of the invention, payment processor 106 may provide a tool or utility for generating the necessary links or methods of redirecting buyer 102 from seller 104 to payment processor 106. For example, seller 104 may connect to payment processor 106 and provide details of a product or service that a buyer may wish to purchase—such as price, minimum or maximum quantity, item name, shipping cost, and so on. The payment processor system may then use those details to generate suitable HTML or other code for the seller to insert at an appropriate location in a web page, online catalog, electronic mail note, etc. This information is transmitted to the payment processor when the buyer's connection (e.g., connection 110 of FIG. 1) is redirected to payment processor 106.

At the payment processor site, the seller may also be able to select and/or customize a button or icon to place with the link, identify (e.g., via URL) an icon or button to use (e.g., with the link and/or within the interface the buyer uses at payment processor 106). A seller may also be able to identify one or more locations (e.g., network addresses, URLs) to send or redirect a buyer connection after the buyer's payment has been processed. For example, a “return URL” may identify a location (e.g., within the seller's web site) to send the buyer to if the payment is successfully processed. A “cancel URL” may be used to identify another location to send the buyer to if the payment processing fails or the buyer cancels the transaction.

In another embodiment of the invention, seller 104 may generate its own HTML or other code for redirecting a buyer's connection to payment processor 106. In this alternative embodiment, certain required parameters and/or formats may be identified for the seller to use in the code. Required parameters may include information such as “item_name” for the name of a product or service; “item_number” for a number identifying the product or service; “amount” for the price to be paid by the buyer; “shipping” for basic shipping cost, if any; “handling” for any handling instructions; “return” for identifying a return URL; “cancel_return” for identifying a cancel URL; “image_URL” for identifying the seller's logo, icon or other graphic, etc.

When a buyer is redirected to payment processor 106, it may be assumed, in one embodiment of the invention, that payment should immediately be solicited and processed for the product(s) and/or service(s) involved in the transaction. In another embodiment, payment processor 106 may provide a third-party shopping cart to track the buyer's purchases. Thus, in this embodiment, when a buyer's connection is redirected, the buyer may be presented with a shopping cart managed by the payment processor. At this third-party shopping cart, the buyer may change the quantity of an item, remove an item from the cart, initiate payment for the items, return to the seller's site, etc. Because the buyer's shopping cart is maintained by the third party, it may be used for purchases or transactions involving multiple sellers.

In the illustrated embodiment of the invention, the experience of buyer 102 at payment processor site 106 depends on the buyer's status with the payment processor. For example, if buyer 102 does not already have an account or is not registered with the payment processor, the first step may be to establish an account or register the buyer, which will entail receiving financial and personal data (e.g., credit card number, bank account information, address). Otherwise, the first step is to simply verify the buyer's identity. In either case, the details of the transaction between the buyer and seller are then verified. Thus, payment processor 106 may display the details of the transaction as reported by the seller. One or more fields (e.g., quantity of product, shipping cost) may be adjusted (by buyer 102 and/or payment processor 106) depending on whether any changes are made. In the final phase, the buyer's financial data is used to initiate electronic payment (e.g., from the buyer's credit card or account with the payment processor to the seller's bank account or account with the payment processor). Then the buyer may be sent or redirected back to the seller.

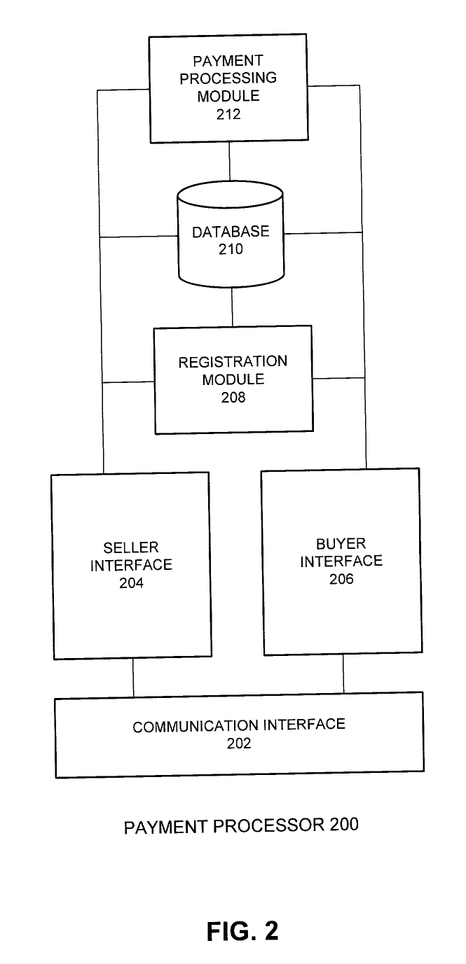

FIG. 2 is a block diagram of a third-party payment processor according to one embodiment of the invention. In this embodiment, payment processor 200 comprises communication interface 202, seller interface 204, buyer interface 206, registration module 208, database 210 and payment processing module 212.

Communication interface 202 receives connections from buyers and sellers, which may include wired and/or wireless links using any suitable communication protocols and architectures. Seller interface 204, as described above, may facilitate the generation of HTML code or other computer readable instructions for transferring a buyer from a seller site to the payment processor and/or transmitting to the payment processor relevant details of an electronic transaction for which payment is to be processed. Seller interface 204 may also be configured to facilitate creation of an account for a seller within payment processor 202.

Buyer interface 206 is configured to elicit necessary information from a buyer to create a new account, retrieve an existing account, identify a desired payment mechanism (e.g., credit card, debit card, bank account), access or update a shopping cart, etc. Because both buyers and sellers may have accounts with payment processor 200, payment from a buyer to a seller may be done using these accounts. Illustratively, the buyer's account may be funded with a credit card or other electronically accessible source of funds, while a seller may withdraw funds or transfer them to a bank account or other electronically accessible destination.

Registration module 208 facilitates the generation of new payment processing accounts for buyers and sellers, while payment processing module 212 interfaces with external financial entities (e.g., banks, credit card issuers, merchant acquirers, ACH vendors) for completing payments from a buyer and/or to a seller.

Database 210 stores various user information concerning buyers and sellers, such as account information, buyer shopping carts, HTML code for sellers, etc.

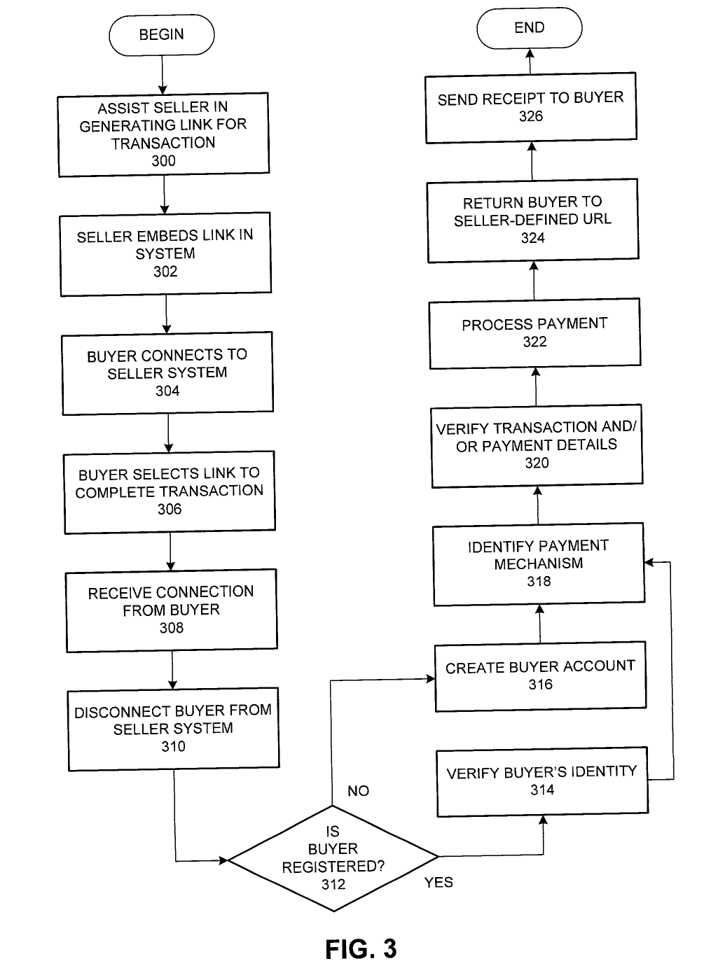

FIG. 3 is a flowchart demonstrating one method of facilitating payment processing through a third party, in accordance with one embodiment of the invention.

In state 300, a third-party payment processor assists a seller in configuring a link, using HTML or other similar coding, for a buyer to select when he or she wishes to complete a transaction (i.e., initiate payment) or access a third-party shopping cart (e.g., to add or remove an item). State 300 may thus include generating the HTML code at the third-party system or specifying for the seller the required parameters and/or structure of the code. If the code is generated at the third-party payment processing system, the seller may be connected to the system at the time (e.g., to provide details of the transaction), or the system may generate the code in response to off-line receipt of the transaction details (e.g., via electronic mail).

In state 302, the seller embeds the HTML or other code in its system. Illustratively, the code may be embedded with a button in a web page, as a URL in an electronic mail note, or in some other form.

In state 304 a buyer connects to the seller's system, to browse an on-line catalog, purchase a good or service, etc. In state 306 the buyer selects the link embedded by the seller in order to initiate payment for a transaction.

In states 308-310 the buyer is nominally disconnected from the seller system and is connected to the third-party processor. In this embodiment, the buyer is redirected from the seller to the payment processor, and the connection with the payment processor is a secure connection. The seller may retain state information regarding the buyer's connection. This may be useful if, for example, the buyer is reconnected to the seller after completing a financial transaction with the third-party payment processor.

In state 312 the third-party payment processor determines whether the buyer is already registered or known. This initial determination may be made based on a user/buyer identity included in the data received with the buyer's connection (i.e., along with details of the transaction), retrieved from a cookie, by asking the buyer if he or she has an account, etc. If the buyer has an account, the illustrated method continues at state 314. Otherwise, the method proceeds to state 316.

In state 314, the buyer's identity is verified. Illustratively, this may be accomplished by eliciting the buyer's payment processor account name and his or her password, which were chosen or set at the time the buyer's account was created. As described above, the buyer's account name may match his or her electronic mail address. Similarly, payment for the transaction (when received from the buyer) may be made to the seller through its account with the payment processor, which may also match a seller electronic mail address. After state 314, the illustrated method advances to state 318.

In state 316 of this method of the invention, the payment processor creates an account for a new or unregistered buyer. The buyer is requested to provide her electronic mail address, which will be used as her account name, and to select a password. In this embodiment, the buyer's account may be used for purposes other than processing a payment with the seller. For example, the buyer's account may be used to send or receive a payment to/from any other user of the system and, possibly, any person having a unique electronic mail address or other unique identifier.

In state 318, the payment processor receives or elicits payment or financial information from the buyer. In particular, the buyer may be prompted to identify a credit card or bank account for paying for the immediate transaction and/or for funding an account for the buyer with the payment processor. The buyer may also be requested to provide other data, such as his or her name, address, telephone number, etc. The various data requested by the system may be used to (further) verify the buyer's identity, identify an appropriate account or instrument for funding the transaction, etc.

In state 320, details of the transaction and/or the method of payment are displayed. One or more of the details may be alterable by the buyer (e.g., quantity of an item being purchased, shipping method, shipping address, credit card, insurance). When the details are acceptable to the buyer, she may select an option to process her payment. Otherwise, she may cancel the transaction.

In state 322, the buyer's payment is processed (unless the buyer chose to cancel the transaction). This may entail removing funds from the buyer's account with the payment processing system or charging the funds to the buyer's credit card. The funds may then be instantly deposited in the seller's account with the system. Ultimately, the funds may be transferred to another (e.g., bank) account or withdrawn by the seller.

In state 324 the buyer is redirected to the seller site if the seller provided an appropriate address (e.g., URL) or site. The buyer may be redirected to different locations, pages or addresses depending on whether he or she completed the transaction successfully or whether the payment was cancelled or unsuccessful. Also, the third-party payment processing system may send (e.g., via electronic mail) a receipt to the buyer if the payment is successfully processed.

The foregoing descriptions of embodiments of the invention have been presented for purposes of illustration and description only. They are not intended to be exhaustive or to limit the invention to the forms disclosed. Accordingly, the above disclosure is not intended to limit the invention; the scope of the invention is defined by the appended claims.

What is claimed is:

1. A method of processing an electronic payment from a payor to a payee at a third party, comprising:
receiving at the third party a first connection from the payor, wherein a second connection between the payor and the payee is terminated when said first connection is received;
creating an account for the payor with the third party for facilitating electronic payments, if said account does not exist; and
electronically transferring funds from the payor to the payee.

2. The method of claim 1, further comprising, prior to said receiving, facilitating the generation of computer readable instructions for replacing said second connection with said first connection.

3. The method of claim 2, wherein said facilitating comprises:
receiving a connection at the third party from the payee;
receiving one or more details of a possible electronic transaction between the payee and a payor; and
generating said computer readable instructions.

4. The method of claim 2, wherein said facilitating comprises:
providing the payee with required parameters for said computer readable instructions;
wherein said computer readable instructions are configured for use on a payee computer system during said second connection.

5. The method of claim 1, further comprising receiving, with said first connection, details of an electronic transaction between the payor and the payee.

6. The method of claim 5, wherein said details include a network address to forward the payor to after said funds are electronically transferred.

7. The method of claim 5, wherein said details include a network address to forward the payor to if the payor cancels said electronic transfer of funds.

8. The method of claim 5, wherein said details include an identifier of a payee account with the third party.

9. The method of claim 1, further comprising redirecting the payor to a network address identified by the payee.

10. The method of claim 1, wherein said creating comprises:
receiving a unique identifier of the payor; and
receiving payment mechanism information from the payor.

11. The method of claim 10, wherein said unique identifier is an electronic mail address.

12. The method of claim 10, wherein said unique identifier is a telephone number.

13. The method of claim 10, wherein said payment mechanism is a credit card.

14. The method of claim 10, wherein said payment mechanism is a debit card.

15. The method of claim 10, wherein said payment mechanism is a bank account.

16. The method of claim 1, further comprising maintaining a shopping cart at the third party for the payor.

17. The method of claim 16, wherein said shopping cart is configured to track the payor's transactions with multiple payees.

18. The method of claim 1, wherein said account is identified by an electronic mail address.

19. A computer readable storage medium storing instructions that, when executed by a computer, cause the computer to perform a method of processing an electronic payment from a payor to a payee at a third party, the method comprising:
receiving at the third party a first connection from the payor, wherein a second connection between the payor and the payee is terminated when said first connection is received;
creating an account for the payor with the third party for facilitating electronic payments, if said account does not exist; and
electronically transferring funds from the payor to the payee.

20. A computer-implemented method of processing a payment from a buyer for a seller at a third-party payment processor, comprising:
receiving a connection from a buyer at a payment processor, wherein said connection replaces a previous connection between the buyer and a seller during which the buyer and the seller arranged an electronic transaction;
receiving one or more criteria of the electronic transaction, including a first value to be paid by the buyer;
verifying with the buyer a source of said first value;
initiating receipt of said first value from the buyer;
initiating payment of a second value to the seller; and
reconnecting the buyer to the seller if said one or more criteria include a destination for said reconnection.

21. The method of claim 20, further comprising:
prior to said receiving a connection, generating a set of computer readable instructions enabling said replacement of the connection between the buyer and the seller;
wherein said computer readable instructions are configured for use on a buyer computer system during said connection between the buyer and the seller.

22. The method of claim 20, further comprising establishing an account for the buyer for electronically transferring value, if said account does not exist.

23. The method of claim 22, wherein said account is identified by an electronic mail address of the buyer.

24. The method of claim 22, wherein said source of said first value is said account.

25. The method of claim 22, wherein said source of said first value is a credit card of the buyer.

26. The method of claim 22, wherein said source of said first value is a bank account of the buyer.

27. The method of claim 20, further comprising transmitting a receipt to the buyer.

28. A computer readable storage medium storing instructions that, when executed by a computer, cause the computer to perform a computer-implemented method of processing a payment from a buyer for a seller at a third-party payment processor, the method comprising:
receiving a connection from a buyer at a payment processor, wherein said connection replaces a previous connection between the buyer and a seller during which the buyer and the seller arranged an electronic transaction;
receiving one or more criteria of the electronic transaction, including a first value to be paid by the buyer;
verifying with the buyer a source of said first value;
initiating receipt of said first value from the buyer;
initiating payment of a second value to the seller; and
reconnecting the buyer to the seller if said one or more criteria include a destination for said reconnection.

29. A payment processor for processing a payment from a payor to a payee, comprising:
a communication interface configured to receive a connection from a payor and details of an electronic transaction between the payor and a payee;
a payor interface configured to verify one or more of said details with the payor;
a registration module configured to create an account for the payor for electronically transferring value; and
a payment module configured to initiate a first payment from the payor and a second payment to the payee;
wherein said communication interface is further configured to connect the payor to the payee.

30. The payment processor of claim 29, further comprising a payee interface configured to facilitate generation of computer readable instructions for redirecting the payor from the payee to the payment processor.

31. The payment processor of claim 29, further comprising a database configured to store a shopping cart for the payor.
